(19) United States
(12) Patent Application Publication
(10) Pub. No.: US 2016/0142876 A1
(43) Pub. Date: May 19, 2016

(54) SYSTEM AND METHOD FOR AD-HOC NETWORK FOR TRACKING THE POSITION OF A SUBJECT

(71) Applicant: WEFIND-TECH LTD, Tel Aviv (IL)

(72) Inventor: Ofer KLEIN, Tel-Aviv (IL)

(73) Assignee: WEFIND-TECH LTD, TEL AVIV (IL)

(21) Appl. No.: 14/899,131

(22) PCT Filed: Jun. 17, 2014
(86) PCT No.: PCT/IL2014/050546

§ 371 Date: Dec. 17, 2015

Related U.S. Application Data
(60) Provisional application No. 61/836,685, filed on Jun. 19, 2013.

(51) Int. Cl. H04W 4/02; H04W 4/00; G01S 5/02

(52) U.S. Cl. CPC H04W 4/023; G01S 5/0294; H04W 4/008; H04W 4/001; H04W 84/18

(57) ABSTRACT

A method and system for tracking a stationary and/or dynamic location of at least one transponder emitting identifying signals, the system comprising: a software application embedded within at least one smart-phone, configured to at least temporarily gather and forwardly transfer the identifying signals emitting from the at least one transponder; at least one communication means for enabling wireless communication between the at least one transponder and the at least one smart-phone; at least one computing server, in wireless communication with the at least one smart-phone; the computing server is configured to collect and aggregate the identifying signals transferred by the at least one smart-phone, by mean of crowd-sourcing data, and accordingly process a real-time estimated location of each of the at least one transponder.

### BACKGROUND

1. Technical Field

Embodiments of the present invention relate generally to systems and methods for ad-hoc networks for tracking the position of one or more subjects.

2. Description of Related Art

Children, pets, people that require supervision (elderly persons, prisoners etc) and important or valuable objects may be lost and apart from their intended location either by disorientation, distraction, theft, or kidnapping. With the increased concern regarding the above there is a need for relatable and quick methods for tracking some or all of the above that will appropriately alert the relevant persons or authorities.

Conventional methods and systems utilize an expensive and complex dedicated system that in most cases does not allow the average person to use any such system for day to day uses and usually are limited to expensive cars and a like.

Hence, improved systems and methods as described in this application are still a long felt need.

### SUMMARY OF THE INVENTION

It is thus one object of the present invention to disclose a system for tracking a stationary and/or dynamic location of at least one user, temporarily defined as subject-user, comprising:
(a) at least three transponders (101,103,104), each associated with a different user; each of the transponders configured to temporarily emit identifying signals, transfer and/or gather the identifying signals emitting from at least one other the transponders;
(b) at least one communication means for enabling wireless communication for the transponders' signals;
(c) at least one computing server (102), in communication with the transponders, configured to control the communication;
   wherein at least one of the transponders, associated with the subject-user, is temporarily characterized as a subject-transponder (101);
   at least two of the transporters are temporarily characterized as tracking-transponders (103,104), configured to temporarily track the signals emitting from the subject-transponder (101), by means of a tracking search for its' the subject-user;
   the computing server (102) is configured to form an ad-hoc communication mesh network (106) between the at least two tracking-transponders (103,104), collect data from their the signals regarding the location of the subject-transponder (101) and accordingly process a real-time estimated location of the subject-transponder (101).

It is another object of the present invention to disclose the system mentioned above, wherein at least one of the transponders configured to temporarily serve as an escort-transponder (103) for at least one of the at least one subject-transponder (101), by means of at least one of the following:
(a) select which of the transponders may participate in the search, as the tracking-transponder;
(b) select which of the transponders may initiate the search;
(c) select which of the tracking-transponders (103,104,105) may terminate the search;
(d) select at least one parameter, by which the search is to be conducted, selected from a group consisting of: at least one predefined location, at least one recent location, and relationship of the subject-user with the users of at least one other of the transponders;
(e) select which of the tracking-transponders (103,104,105) may receive, from the computing server (102) or via the transponders, real-time and/or off-line tracking information, regarding the search; and
(f) select which of the tracking-transponders (103,104,105) may invite at least one new tracking-transponder to participate in the search; invitation may be sent to an exciting the user or a new user introduced with the transponders.

It is another object of the present invention to disclose the system mentioned above, wherein the data collection is directly from the tracking-transponders, which communicate with the subject-transponder and/or via other the tracking-transponders, by means of the mesh-network (106).

It is another object of the present invention to disclose the system mentioned above, wherein the system is utilized by a software application, configured to be instantly downloaded.

It is another object of the present invention to disclose the system mentioned above, wherein each of the transponders is embedded within a device (108) selected from a group consisting of: smart-phone, desktop computer, laptop computer, bracelet, necklace, tablet, and any combination thereof.

It is another object of the present invention to disclose the system mentioned above, wherein the device is configured for wireless communication, at least partial wireless communication and/or non-wireless communication.

It is another object of the present invention to disclose the system mentioned above, wherein the computing server (102) is temporarily embedded within at least one of the transponders.

It is another object of the present invention to disclose the system mentioned above, wherein the means for communication (106) is selected from a group of: Bluetooth, Bluetooth Low Energy (BLE), Wi-Fi, Sub-Giga, cellular, ZigBee, Radio-frequency, Radio-frequency identification (RFID), and any combination thereof;

It is another object of the present invention to disclose the system mentioned above, wherein the system further comprising a database (107), embedded within the computing server (102), configured to store at least one feature of at least one of the transponders; the feature selected from a group consisting of: recent location, most popular locations, communication properties, contact information, relation status with other the users, contact information of related other the users, personal appearance, and medical record.

It is another object of the present invention to disclose the system mentioned above, wherein the computing server (102) configured to transfer at least of the at least one feature to at least one predetermined the transponders.

It is another object of the present invention to disclose the system mentioned above, wherein the process of the estimated location is achieved by means of triangulation; the estimated location may be denoted with or without intentional direction.

It is another object of the present invention to disclose the system mentioned above, wherein the subject-user is a human, an animal, or an object.

It is another object of the present invention to disclose the system mentioned above, wherein the search is initiated by at least one event selected from a group consisting of:
(a) an initiation by at least one predetermined the transponders;
(b) an initiation by the escort-transponder (103);
(c) an initiation by the subject-transponder (101);
(d) the subject-transponder is located within a predetermined unsafe area;
(e) the subject-transponder is located outside of a predetermined safe area;
(f) distance of the subject-transponder (101) from its escort-transponder (103), a predetermined transponder, and/or predetermined location is above a predetermined value; and
(g) distance of the subject-transponder (101) from a predetermined transponder, and/or predetermined location is below a predetermined value.

It is another object of the present invention to disclose the system mentioned above, wherein the at least two tracking-transponders selected according at least one feature selected from a group consisting of:
(a) perimeter distance from last known location of the subject-transponder (101);
(b) perimeter distance from the escort-transponder (103);
(c) perimeter distance from at least one of the tracking-transponders (103,104,105) recently receiving the signal from the subject-transponder (101); and
(d) predetermined relation between the subject-user and the user of at least one of the transponders.

It is another object of the present invention to disclose the system mentioned above, wherein the subject-transponder (101) may also be temporarily characterized as the tracking-transponder, therefore also included in the mesh network (106).

It is another object of the present invention to disclose the system mentioned above, wherein the ad-hoc communication mesh network (106) is at least partially supported by communication crowd-sourcing network.

It is another object of the present invention to disclose the system mentioned above, wherein at least one of the transponders is configured as a communication node.

It is another object of the present invention to disclose a method for tracking location of at least one user, temporarily defined as subject-user, comprising steps of:
(a) providing at least three users with transponders (101,103,104); the transponders configured to temporarily emit identifying signals, transfer and/or gather the identifying signals emitting from other the transponders;
(b) providing means for enabling communication between the transponders' signals and a central computing (102) for controlling the communication;
(c) initiating a search;
(d) temporarily characterizing at least one of transponders, associated with the subject-user, as a subject-transponder (101);
(e) temporarily characterizing at least two of transponders as tracking-transponders (103,104), configured for tracking the signals emitting from the subject-transponder (101);
(f) forming an ad-hoc communication mesh network (106) between the at least two tracking-transponders (103,104);
(g) collecting data from the signals of the tracking-transponders regarding the location of the subject-transponder (101);
(h) processing the data to a real-time estimated location of the subject-transponder (101); and
(i) terminating the search, by at least one predetermined tracking-transponder, and/or by a predetermined event of locating the subject-transponder (101).

It is another object of the present invention to disclose the method mentioned above, further comprising step of temporarily characterizing at least one of the transponders to serve as an escort-transponder (103) for at least one of the subject-transponder (101), by means of at least one of the following:
(a) selecting which of the transponders may participate in the search, as the tracking-transponder;
(b) selecting which of the transponders may initiate the search;
(c) selecting which of the tracking-transponders (103,104,105) may terminate the search;
(d) selecting at least one parameter, by which the search is to be conducted, selected from a group consisting of: at least one predefined location, at least one recent location, and relationship of subject-user with the users of at least one other the transponders;
(e) selecting which of the tracking-transponders (103,104,105) may receive real-time and/or off-line tracking information, regarding the search; and
(f) selecting which of the tracking-transponders (103,104,105) may invite at least one new tracking-transponder to participate in the search; invitation may be sent to an exciting the user or a new user introduced with the transponders.

It is another object of the present invention to disclose the method mentioned above, wherein the step of collecting the data is conducted directly from the tracking-transponders, which communicate with the subject-transponder and/or via other the tracking-transponders, by means of the mesh-network (106).

It is another object of the present invention to disclose the method mentioned above, further comprising step of utilizing the method by a software application, configured to be instantly downloaded.

It is another object of the present invention to disclose the method mentioned above, further comprising step of embedding the transponders within a device (108) selected from a group consisting of: smart-phone, desktop computer, laptop computer, bracelet, necklace, tablet, and any combination thereof.

It is another object of the present invention to disclose the method mentioned above, wherein the device is configured for wireless communication, at least partial wireless communication and/or non-wireless communication.

It is another object of the present invention to disclose the method mentioned above, further comprising step of temporarily embedding the computing server (102) within at least one of the transponders.

It is another object of the present invention to disclose the method mentioned above, further comprising step of selecting the means for communication (106) from a group of: Bluetooth, Bluetooth Low Energy (BLE), Wi-Fi, Sub-Giga, cellular, ZigBee, Radio-frequency, Radio-frequency identification (RFID), and any combination thereof;

It is another object of the present invention to disclose the method mentioned above, further comprising a step of providing a database (107), embedded within the computing server (102), configured for storing at least one feature of at least one of the transponders; the feature selected from a group consisting of: recent location, most popular locations, communication properties, the subject-user's contact information, the subject-user's relation status with other the users, contact information of related other the users, the subject-user's personal appearance, and the subject-user's medical record.

It is another object of the present invention to disclose the method mentioned above, further comprising step of transferring at least of the at least one feature to at least one predetermined the transponders.

It is another object of the present invention to disclose the method mentioned above, wherein the step of processing of the estimated location is achieved by means of triangulation, and the estimated location may be denoted with or without intentional direction.

It is another object of the present invention to disclose the method mentioned above, wherein the subject-user is a human, an animal, or an object.

It is another object of the present invention to disclose the method mentioned above, wherein the step of initiating is according to at least one event selected from a group consisting of:
(a) an initiation by at least one predetermined the transponders and/or an initiation by the escort-transponder (103) of the subject-transponder;
(b) the subject-transponder is located within a predetermined unsafe area;
(c) the subject-transponder is located outside at a predetermined safe area;
(d) distance of the subject-transponder from its escort-transponder, a predetermined transponder, and/or predetermined location is above a predetermined value; and
(e) distance of the subject-transponder from a predetermined transponder, and/or predetermined location is below a predetermined value.

It is another object of the present invention to disclose the method mentioned above, wherein the step of selecting the at least two tracking-transponders (103,104) is according at least one feature selected from a group consisting of:
(a) perimeter distance from last known location of the subject-transponder (101);
(b) perimeter distance from the escort-transponder (103);
(c) perimeter distance from at least one of the tracking-transponders (103,104,105) recently receiving the signal from the subject-transponder (101); and
(d) predetermined relation between the subject-user of the subject-transponder (101) and the user of at least one of the transponders.

It is another object of the present invention to disclose the method mentioned above, further comprising step of temporarily characterizing the subject-transponder (101) also as the tracking-transponder, thereby also included in the mesh network (106).

It is another object of the present invention to disclose the method mentioned above, wherein the ad-hoc communication mesh network (106) is at least partially supported by wireless crowd-sourcing network.

It is another object of the present invention to disclose the method mentioned above, wherein at least one of the transponders is configured as a communication node.

It is another object of the present invention to disclose the method mentioned above, further comprising steps of:
(a) initiating the software application;
(b) searching for available the crowd-sourcing network; and
(c) connecting the transponder to the ad-hoc communication mesh network, via the crowd-sourcing wireless network.

It is another object of the present invention to disclose a system (400) for tracking a stationary and/or dynamic location of at least one transponder (101) emitting identifying signals, the system (400) comprising:
(a) a software application embedded within at least one smart-phone (103), configured to at least temporarily gather and forwardly transfer the identifying signals emitting from the at least one transponder;
(b) at least one communication means for enabling wireless communication between the at least one transponder and the at least one smart-phone;
(c) at least one computing server (102), in wireless communication with the at least one smart-phone (101);
   wherein the computing server (102) is configured to collect and aggregate the identifying signals transferred by the at least one smart-phone, by mean of crowd-sourcing data, and accordingly process a real-time estimated location of each of the at least one transponder (103,104).

It is another object of the present invention to disclose the system mentioned above, wherein at least one of the smart-phone receives real-time and/or off-line tracking information, regarding location of at least one other the transponder.

It is another object of the present invention to disclose the system mentioned above, wherein the signals collection is directly from each of the transponders and/or via other the transponders.

It is another object of the present invention to disclose the system mentioned above, wherein the software application is instantly downloaded.

It is another object of the present invention to disclose the system mentioned above, wherein each of the transponders (103,104) is embedded within a device (108) selected from a group consisting of: smart-phone, desktop computer, laptop computer, bracelet, necklace, tablet, and any combination thereof.

It is another object of the present invention to disclose the system mentioned above, wherein the computing server (102) is temporarily embedded within at least one of the at least one transponder and/or one of the at least one smart-phone.

It is another object of the present invention to disclose the system mentioned above, wherein the means for communication (106) is selected from a group of: Bluetooth, Bluetooth Low Energy (BLE), Wi-Fi, Sub-Giga, cellular, ZigBee, Radio-frequency, Radio-frequency identification (RFID), and any combination thereof;

It is another object of the present invention to disclose the system mentioned above, wherein the system further comprising a database (107), embedded within the computing server (102), configured to store at least one feature of at least one of the transponders and/or the at least one smart-phone; the feature selected from a group consisting of: recent location, most popular locations, communication properties, contact information, relation status with other the users, personal appearance, and medical record.

It is another object of the present invention to disclose the system mentioned above, wherein the computing server (102) configured to transfer at least of the at least one feature to at least one of the at least one smart-phone.

It is another object of the present invention to disclose the system mentioned above, wherein the process of the estimated location is achieved by means of triangulation; the estimated location may be denoted with or without intentional direction.

It is another object of the present invention to disclose the system mentioned above, wherein the communication means is at least partially supported by crowd-sourcing network.

It is another object of the present invention to disclose the system mentioned above, wherein at least one of the smart-phones is configured as a communication node.

It is another object of the present invention to disclose a system for tracking the position of a subject, the system comprising: at least one transponder configured for being located; at least one transponder configured for enabling and disabling tracking session; at least two transponders configured for tracking the at least one transponder configured for being located; and means for enabling communication between the transponders, wherein an ad-hoc wireless or semi-wireless network comprising the at least two transponders configured for tracking and the at least one transponder configured for enabling tracking session, the network is configured for enabling the at least two transponders configured for tracking to communicate with the at least one transponder configured for being located while in communication range and sending information regarding the communication.

It is another object of the present invention to disclose the system mentioned above, wherein the at least one transponder configured for being located location is calculated according to the information sent via the ad-hoc wireless or semi-wireless network.

It is another object of the present invention to disclose the system mentioned above, wherein the at least two transponders configured for tracking joins the ad-hoc wireless network based on distance from the at least one transponder configured for enabling and disabling tracking session.

It is another object of the present invention to disclose the system mentioned above, wherein the at least two transponders configured for tracking joins the ad-hoc wireless network based on distance from the expected position of the at least one transponder configured for been located.

It is another object of the present invention to disclose the system mentioned above, wherein the at least two transponders configured for tracking joins the ad-hoc wireless network based on their affiliation with a pre-defined group.

It is another object of the present invention to disclose a method for tracking the position of a subject, the method comprising: establishing a mesh ad-hoc wireless or semi-wireless network comprising at least two transponders configured for tracking the at least one transponder configured for being located and at least one transponder configured for enabling and disabling tracking session; and at least one transponder configured for being located, wherein the at least two transponders are configured to determine if the least one transponder configured for being located is within communication range and to store communication information; the mesh network is configured to transmit the communication information.

It is further within provision of the invention to further comprise calculation of the location of the at least one transponder configured to be located according to the communication information sent via the network.

It is another object of the present invention to disclose a method for tracking the position of a subject, the method comprising steps of: providing at least one transponder configured for being located; initiating a locating session; determining relevant transponders for the session; initiating a mesh ad-hoc wireless or semi-wireless network; sending session start instruction to transponders configured for tracking an object; receiving acknowledgement or decline communication from the transponders; joining acknowledging transponders to the mesh network; and receiving communication from the transponders regarding their communication or lack of communication with the transponder configured for being located, wherein the at least one transponder configured to initiate tracking session receives the communication regarding their communication or lack of communication with the transponder configured for being located via the mesh network.

Another aspect of the present invention provides a method for choosing relevant transponders to track a transponder configured for being located comprising: providing at least one transponder configured for being located; initiating a search session; determining relevant transponders for the session; initiating a mesh ad-hoc wireless or semi-wireless network; sending session start instruction to transponders configured for tracking an object; receiving acknowledgement or decline communication from the transponders; joining acknowledging transponders to the mesh network; and receiving communication from the transponders regarding their communication or lack of communication with the transponder configured for being located, wherein the at least one transponder configured to initiate tracking session receives the communication regarding their communication or lack of communication with the transponder configured for being located via the mesh network.

Another aspect of the present invention provides a method for calculating the location of a transponder configured for being located using wireless or semi-wireless mesh network comprising: providing at least one transponder configured for being located; initiating a locating session; determining relevant transponders for the session; initiating a mesh ad-hoc wireless or semi-wireless network; sending session start instruction to transponders configured for tracking an object; receiving acknowledgement or decline communication from the transponders; joining acknowledging transponders to the mesh network; and receiving communication from the transponders regarding their communication or lack of communication with the transponder configured for being located, wherein the at least one transponder configured to initiate tracking session receives the communication regarding their communication or lack of communication with the transponder configured for being located via the mesh network.

It is further within provision of the invention to further comprise providing a reconstruction of the at least one transponder configured for being located according to stored information received from the at least one transponder configured for tracking an object and displaying it using a user interface of a computing device.

Another aspect of the present invention provides a non-transitory computer-readable medium storing processor executable instructions for performing a method for tracking on a computing device, comprising: one or more instructions which, when executed by at least one hardware processor controlling at least one transponder, cause the at least one hardware transponder to receive and response to signals that will allow at least one other transponder to acknowledge the identity of the computing device.

It is further within provision of the invention to further comprise instructions that cause the at least one hardware processor to calculate, in real time, statistics regarding a search session

Another aspect of the present invention provides a non-transitory computer-readable medium storing processor executable instructions for performing a method for tracking on a computing device, comprising: one or more instructions which, when executed by at least one hardware processor controlling at least one transponder, cause the at least one hardware transponder to send and receive signals that will allow at least one other transponder in a predefined computing device to acknowledge the identity of the predefined computing device.

It is further within provision of the invention to further comprise instructions that cause the at least one hardware processor to calculate, in real time, statistics regarding a search session

Another aspect of the present invention provides a non-transitory computer-readable medium storing processor executable instructions for performing a method for tracking on a computing device, comprising: one or more instructions which, when executed by at least one hardware processor controlling at least one transponder and after receiving an initiation instruction from a user cause the at least one hardware transponder to send and receive signals that will allow at least one other transponder in a predefined computing device to acknowledge the identity of the predefined computing device; one or more instructions which, when executed by at least one hardware processor controlling at least one transponder and after receiving an initiation instruction from a user cause the at least one hardware transponder to communicate with at least one other computing device and instructing the at least one other computing device to initiate sending and receiving signals that will allow the at least one other transponder in a predefined computing device to acknowledge the identity of the predefined computing device.

It is further within provision of the invention to further comprise instructions that cause the at least one hardware processor to calculate, in real time, statistics regarding a search session.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which:

FIG. 1 illustrates an embodiment of the system;

FIG. 2 is a flowchart illustrating a method of the current invention;

FIGS. 3A and 3B illustrate a search expansion example; and

FIG. 4 illustrates another embodiment of the system.

### DETAILED DESCRIPTIONS OF THE INVENTION

The following description is provided, alongside all chapters of the present invention, so as to enable any person skilled in the art to make use of the invention and sets forth the best modes contemplated by the inventor of carrying out this invention. Various modifications, however, will remain apparent to those skilled in the art, since the generic principles of the present invention have been defined specifically to provide a means and method for providing systems and methods for to a web browser or a web browser add on or extension.

In the following detailed description, numerous specific details are set forth in order to provide a thorough understanding of embodiments of the present invention. However, those skilled in the art will understand that such embodiments may be practiced without these specific details. Just as each feature recalls the entirety, so it may yield the remainder. And ultimately when the features manifest, so an entirely new feature be recalled. Reference throughout this specification to “one embodiment” or “an embodiment” means that a particular feature, structure, or characteristic described in connection with the embodiment is included in at least one embodiment of the invention.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, or C” and “A, B, and/or C” means A alone, B alone, C alone, A and B together, A and C together, B and C together, or A, B and C together.

The term “plurality” refers hereinafter to any positive integer (e.g, 1,5, or 10).

The term “transponder” may refer hereinafter to telecommunication and/or data device, such devices: emit an identifying signal in response to an interrogating received signal, and/or, gather signals over a range of frequencies and re-transmits them on same or different set of frequencies (with or without changing the content of the received signals). For the purpose of this application the transponders could be, for example, any stationary wireless station, hand held device with any communication capabilities, mobile/cellular phone and/or network unique devices. The transponder may utilize, for example at least one of the following communication technologies: Cellular networks, satellite networks, WiFi, Bluetooth, various RF (such as 430 MGH, 900 MGH, etc), Near Field Communication protocols (NFC), RFID, Zigbee etc.

The terms “subject's computing device”, “escort's computing device” and “tracker's computing device” may refer hereinafter to any computing device comprising a transponder (and is used as the subject's/escort's/tracker's device). The devices are interchangeable and may be used for different purposes in different times; for example, escort's device may perform all the tracker's device abilities.

The term “subject” may refer hereinafter to any person, pet, object etc that one wishes to track or is being tracked.

The term “escort” may refer hereinafter to the owner, guardian, escort etc of the subject.

The term “crowd-sourcing network” may refer hereafter to a communication network that is created out of people, businesses and/or authorities sharing a portion of their private WiFi connections with the public.

The term “node” may refer hereafter to an active electronic device or the disclosed transponder that is attached to a network, and is capable of sending, receiving, or forwarding information over a communications channel.

The term “crowd-sourcing data” may refer hereafter to a communication network that is created out of people, businesses and/or authorities sharing data with the public.

The present invention provides a system for tracking a stationary and/or dynamic location of at least one user, temporarily defined as subject-user, comprising:
(a) at least three transponders (101,103,104), each associated with a different user; each of the transponders configured to temporarily emit identifying signals, transfer and/or gather the identifying signals emitting from at least one other the transponders;
(b) at least one communication means for enabling wireless communication for the transponders' signals;
(c) at least one computing server (102), in communication with the transponders, configured to control the communication;
wherein at least one of the transponders, associated with the subject-user, is temporarily characterized as a subject-transponder (101);
   at least two of the transporters are temporarily characterized as tracking-transponders (103,104), configured to temporarily track the signals emitting from the subject-transponder (101), by means of a tracking search for its' the subject-user;
   the computing server (102) is configured to form an ad-hoc communication mesh network (106) between the at least two tracking-transponders (103,104), collect data from their the signals regarding the location of the subject-transponder (101) and accordingly process a real-time estimated location of the subject-transponder (101).

According to an embodiment of present invention, at least one of the transponders configured to temporarily serve as an escort-transponder (103) for at least one of the at least one subject-transponder (101), by means of at least one of the following:
(a) select which of the transponders may participate in the search, as the tracking-transponder;
(b) select which of the transponders may initiate the search;
(c) select which of the tracking-transponders (103,104,105) may terminate the search;
(d) select at least one parameter, by which the search is to be conducted, selected from a group consisting of: at least one predefined location, at least one recent location, and relationship of the subject-user with the users of at least one other of the transponders;
(e) select which of the tracking-transponders (103,104,105) may receive, from the computing server (102) or via the transponders, real-time and/or off-line tracking information, regarding the search; and
(f) select which of the tracking-transponders (103,104,105) may invite at least one new tracking-transponder to participate in the search; invitation may be sent to an exciting the user or a new user introduced with the transponders.

According to an embodiment of present invention, the data collection is directly from the tracking-transponders, which communicate with the subject-transponder and/or via other the tracking-transponders, by means of the mesh-network (106).

According to an embodiment of present invention, the system is utilized by a software application, configured to be instantly downloaded.

According to an embodiment of present invention, each of the transponders is embedded within a device (108) selected from a group consisting of: smart-phone, desktop computer, laptop computer, bracelet, necklace, tablet, and any combination thereof.

According to an embodiment of present invention, the device is configured for wireless communication, at least partial wireless communication and/or non-wireless communication.

According to an embodiment of present invention, the computing server (102) is temporarily embedded within at least one of the transponders.

According to an embodiment of present invention, the means for communication (106) is selected from a group of: Bluetooth, Bluetooth Low Energy (BLE), Wi-Fi, Sub-Giga, cellular, ZigBee, Radio-frequency, Radio-frequency identification (RFID), and any combination thereof;

It According to an embodiment of present invention, the system further comprising a database (107), embedded within the computing server (102), configured to store at least one feature of at least one of the transponders; the feature selected from a group consisting of: recent location, most popular locations, communication properties, contact information, relation status with other the users, contact information of related other the users, personal appearance, and medical record.

According to an embodiment of present invention, the computing server (102) configured to transfer at least of the at least one feature to at least one predetermined the transponders.

According to an embodiment of present invention, the process of calculating the estimated location is achieved by means of triangulation; the estimated location may be denoted with or without intentional direction.

According to an embodiment of present invention, the subject-user is a human, an animal, or an object.

According to an embodiment of present invention, the search is initiated by at least one event selected from a group consisting of:
(a) an initiation by at least one predetermined the transponders;
(b) an initiation by the escort-transponder (103);
(c) an initiation by the subject-transponder (101);
(d) the subject-transponder is located within a predetermined unsafe area;
(e) the subject-transponder is located outside of a predetermined safe area;
(f) distance of the subject-transponder (101) from its escort-transponder (103), a predetermined transponder, and/or predetermined location is above a predetermined value; and
(g) distance of the subject-transponder (101) from a predetermined transponder, and/or predetermined location is below a predetermined value.

According to an embodiment of present invention, the at least two tracking-transponders are selected according at least one feature selected from a group consisting of:
(a) perimeter distance from last known location of the subject-transponder (101);
(b) perimeter distance from the escort-transponder (103);
(c) perimeter distance from at least one of the tracking-transponders (103,104,105) recently receiving the signal from the subject-transponder (101); and
(d) predetermined relation between the subject-user and the user of at least one of the transponders.

According to an embodiment of present invention, the subject-transponder (101) may also be temporarily characterized as the tracking-transponder, therefore also included in the mesh network (106).

According to an embodiment of present invention, the ad-hoc communication mesh network (106) is at least partially supported by communication crowd-sourcing network.

According to an embodiment of present invention, at least one of the transponders is configured as a communication node.

The present invention further provides a method for tracking location of at least one user, temporarily defined as subject-user, comprising steps of:
(a) providing at least three users with transponders (101,103,104); the transponders configured to temporarily emit identifying signals, transfer and/or gather the identifying signals emitting from other the transponders;
(b) providing means for enabling communication between the transponders' signals and a central computing (102) for controlling the communication;
(c) initiating a search;
(d) temporarily characterizing at least one of transponders, associated with the subject-user, as a subject-transponder (101);
(e) temporarily characterizing at least two of transponders as tracking-transponders (103,104), configured for tracking the signals emitting from the subject-transponder (101);
(f) forming an ad-hoc communication mesh network (106) between the at least two tracking-transponders (103,104);
(g) collecting data from the signals of the tracking-transponders regarding the location of the subject-transponder (101);
(h) processing the data to a real-time estimated location of the subject-transponder (101); and
(i) terminating the search, by at least one predetermined tracking-transponder, and/or by a predetermined event of locating the subject-transponder (101).

According to an embodiment of present invention, the method mentioned above, further comprising step of temporarily characterizing at least one of the transponders to serve as an escort-transponder (103) for at least one of the subject-transponder (101), by means of at least one of the following:
(a) selecting which of the transponders may participate in the search, as the tracking-transponder;
(b) selecting which of the transponders may initiate the search;
(c) selecting which of the tracking-transponders (103,104,105) may terminate the search;
(d) selecting at least one parameter, by which the search is to be conducted, selected from a group consisting of: at least one predefined location, at least one recent location, and relationship of subject-user with the users of at least one other the transponders;
(e) selecting which of the tracking-transponders (103,104,105) may receive real-time and/or off-line tracking information, regarding the search; and
(f) selecting which of the tracking-transponders (103,104,105) may invite at least one new tracking-transponder to participate in the search; invitation may be sent to an exciting the user or a new user introduced with the transponders.
(g) It is another object of the present invention to disclose the method mentioned above, wherein the step of collecting the data is conducted directly from the tracking-transponders, which communicate with the subject-transponder and/or via other the tracking-transponders, by means of the mesh-network (106).

According to an embodiment of present invention, the step of initiating is according to at least one event selected from a group consisting of:
(a) an initiation by at least one predetermined the transponders and/or an initiation by the escort-transponder (103) of the subject-transponder;
(b) the subject-transponder is located within a predetermined unsafe area;
(c) the subject-transponder is located outside at a predetermined safe area;
(d) distance of the subject-transponder from its escort-transponder, a predetermined transponder, and/or predetermined location is above a predetermined value; and
(e) distance of the subject-transponder from a predetermined transponder, and/or predetermined location is below a predetermined value.

According to an embodiment of present invention, the method mentioned above, further comprising steps of:
(a) initiating the software application;
(b) searching for available the crowd-sourcing network; and
(c) connecting the transponder to the ad-hoc communication mesh network, via the crowd-sourcing wireless network.

The present invention further provides a system (400) for tracking a stationary and/or dynamic location of at least one transponder (101) emitting identifying signals, the system (400) comprising:
(a) a software application embedded within at least one smart-phone (103), configured to at least temporarily gather and forwardly transfer the identifying signals emitting from the at least one transponder;
(b) at least one communication means for enabling wireless communication between the at least one transponder and the at least one smart-phone;
(c) at least one computing server (102), in wireless communication with the at least one smart-phone (101);
   wherein the computing server (102) is configured to collect and aggregate the identifying signals transferred by the at least one smart-phone, by mean of crowd-sourcing data, and accordingly process a real-time estimated location of each of the at least one transponder (103,104).

According to an embodiment of present invention, at least one of the smart-phone receives real-time and/or off-line tracking information, regarding location of at least one other the transponder.

According to an embodiment of present invention, the signals collection is directly from each of the transponders and/or via other the transponders.

According to an embodiment of present invention, the software application is instantly downloaded.

According to an embodiment of present invention, each of the transponders (103,104) is embedded within a device (108) selected from a group consisting of: smart-phone, desktop computer, laptop computer, bracelet, necklace, tablet, and any combination thereof

According to an embodiment of present invention, the computing server (102) is temporarily embedded within at least one of the at least one transponder and/or one of the at least one smart-phone.

According to an embodiment of present invention, the means for communication (106) is selected from a group of: Bluetooth, Bluetooth Low Energy (BLE), Wi-Fi, Sub-Giga, cellular, ZigBee, Radio-frequency, Radio-frequency identification (RFID), and any combination thereof;

According to an embodiment of present invention, the system further comprising a database (107), embedded within the computing server (102), configured to store at least one feature of at least one of the transponders and/or the at least one smart-phone; the feature selected from a group consisting of: recent location, most popular locations, communication properties, contact information, relation status with other the users, personal appearance, and medical record.

According to an embodiment of present invention, the computing server (102) configured to transfer at least of the at least one feature to at least one of the at least one smart-phone.

According to an embodiment of present invention, the communication means is at least partially supported by crowd-sourcing network.

According to an embodiment of present invention, at least one of the smart-phones is configured as a communication node.

The invention presents a solution for allowing communities to provide a safer environment to members of the community. The invention allows the creation and operation of a collaborative and crowd sourced system to track and monitor the location and state of a subject, for example their loved ones, and call for community help in tracking the subject when required.

The invention utilizes existing communication devices in order to create an ad-hoc network with unlimited number of nodes, each node acts as a tracking device and/or rely station for other nodes. Each node's location is known to the system hence allowing the tracking of the subject.

The invention has an exponential growth allowing the number of tracker devices to grow based on geographical indicator.

In one embodiment of the invention the system comprises a software application or applications suitable for running on computing devices (for example computers, hand held devices, smart-phones, wireless access points, etc.). The software application may run in the background of the computing devices or be activated only when appropriate.

The software application may be divided into three different modules that may be embedded in the same application or divided into one or more applications:
Tracking subject module—a module configured to allow computing devices to serve as the tracked subject, for example, suitable for running on a child's cellular phone, smart watch, laptop etc.
Tracker devices module—a module configured to allow the computing device to serve as a tracker, i.e. to actively or passively search for a subject, and for example is suitable for running on any stationary device that has a known location, for example wireless access points and any mobile devices such as cellular phones carried by persons from the community, police officers and other authorities officers, etc.
Tracker managing module—a module configured to allow enabling and disabling of a search, for example, suitable for running of parents cellular phone or home computer as well as on police and other relevant authorities' stationary or mobile computing devices.

In some embodiments of the invention a central server may be part of the system, in an embodiment of the invention the central server may be computing device that initiate and/or manage the tracking.

In one embodiments of the invention, the escort of the subject may download the software application mentioned above, with at least the tracker managing module, to his computing device, for example to his smart-phone. In addition, the escort may download the software application, with at least the tracking subject module to the subject's computing device, for example his child smart-phone.

Once the escort's computing device and the subject's computing device are identified by the central server, for example by way of logging into the system with user name and password, using MAC address or any other means of identification known in the art, the escort may associate his device with at least one subject's device in a manner that will allow at least one of the devices to activate the tracking using a predefined parameters that may include relevant trackers properties:
a. searcher's parameters—for example, an escort or the system may decide that the search for his child will be done only by family members. In this case, the child may be escorted by his grandmother, in that way the escort may avoid a wide search. In another example, an escort or the system may decide that for example in a case of a lost pet that only those users or computing devices that were predefined as wishing to help searching for pets will be activated;
b. location parameters—for example, an escort or the system may decide to search only the proximity of the child's house and then the child might be located, for example, in the WiFi range of the house's router. In another example, an escort or the system may decide to search only the proximity of the last known location of a subject;

In addition, a plurality of other devices, stationeries and/or mobile computing devices may be deployed with at least the software application's tracker devices module.

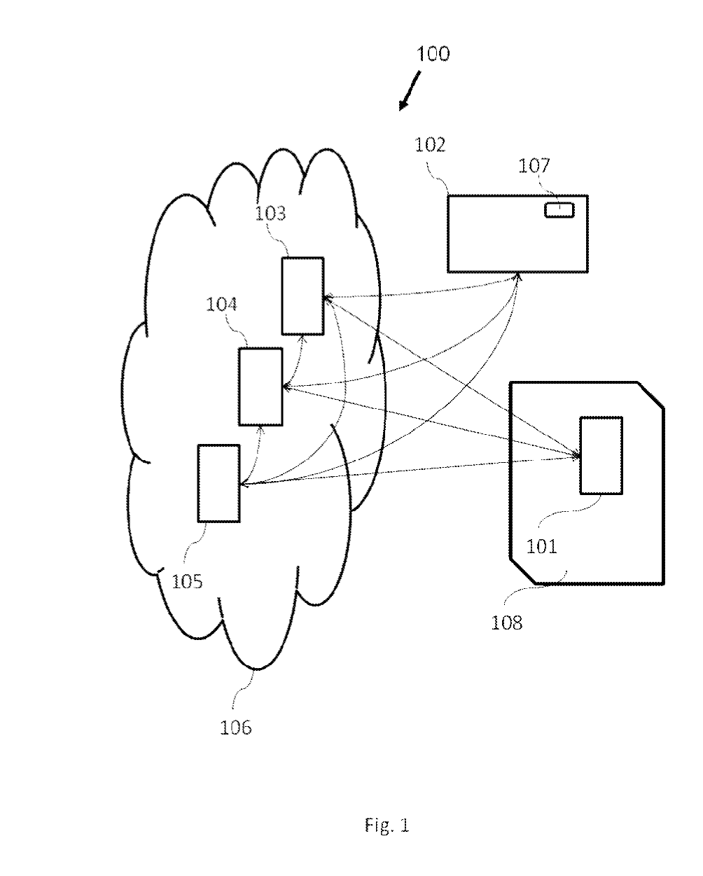

FIG. 1 illustrates an example of the system (100), comprising a transponder by means of the subject's computing device (101), configured for being located; a central server (102); a transponder by means of an escort's computing device (103), configured for enabling and disabling a tracking session (in this example also wireless tracker); a wired transponder (104), configured for tracking the at least one transponder (101) configured for being located; and a wireless transponder (105), configured for tracking the at least one transponder (101) configured for being located. The transponders (103,104,105) participating in the search session form an ad-hoc network (106).

Once a tracking session is initiated, for example by the escort, by the subject, or due to an initiating event, the initiation note is than distributed between all the predefined trackers population. Once a computing device with the tracker devices module receives such search initiation note it will start searching. In some embodiments of the invention the search will start automatically. In other embodiments, a user's approval will be required. In different embodiments, each user may predefine whether a user approval or a predetermined input is required.

The information provided to the tracker devices may include nothing more than identification information that will allow the tracker devices to recognize the subject's device. Such identification information may include:
a. a key generated by the system;
b. a MAC address;
c. an SSID;
d. etc.

In other embodiments of the invention, the information will further include the last known location of the subject or subject's devices, the escort's identification information, ways to contact the subject and/or the escort outside the system, sensors' data such as accelerometer, gyro and magnetometer proximity to other devices and/or wireless stations in the area.

The trackers, while in a search session, will activate their transponders capabilities and deploy at least one communication capability in order to scan their surroundings in order to locate the subjects' devices. For example:
a. In case the tracker computing device is a smart-phone—Bluetooth, WiFi, FM and NFC capabilities may be deployed;
b. In case the tracker computing device is a WiFi router or hub—WiFi capabilities may be deployed;
c. In case the tracker computing device is a Bluetooth router or hub—Bluetooth capabilities may be deployed.

Each tracker device may, while in search session, become a mobile or stationary hot spot, hence becoming a relay station as well as a tracking device. The relay station will be limited to the relaying communications from other devices that participate in the search session. The relay station allows range expansion, particularly in cases that communication by devices is limited, for example inside buildings, underground, in rural areas etc. The system may allow the devices to communicate between each other with or without reporting to a central server hence allowing a decentralized system.

Once a tracker communicates and identifies the subject's computing device identity it will transfer the recognition information and location information to the central server and/or the escort's computing device. In some embodiments of the invention, the tracker communicating and identifying the subject's computing device will not have a direct way to send the information to the central server and/or the escort's computing device and other devices that will function as relay and will re-send the information until a computing device with an access point will receive the information and transmit it to the central server and/or the escort's computing device.

In many cases, more than one tracker device will communicate with the subject's device. This will allow the calculation of the location of the subject's device. The search session may include several kinds of tracking device communicating with the subject's device, for example, when the subject's device is a smart-phone it may parallel or semi-parallel communicate with another smart-phone using Bluetooth, a tablet computer using WiFi, an internet hot spot using WiFi and with RF directional transmitter. The system will then receive all the information and will calculate the exact location of the subject's device, for example by means of triangulation (with or without directional information, if available). In case that an exact location cannot be calculated, an approximated location may be calculated and reported to the escort.

The escort will be presented, in real-time or near it, with all the information sent from the tracker devices. In some embodiments of the invention, the information will be presented using a specialized user interface. The user's interface may include:
a. a “Radar” screen that may present the relative direction from the user's location to any predefined devices (including the subject's device);
b. a map view showing the user's location and the location of any predefined devices (including the subject's device);
c. a “call for help” user interface option to initiate ad-hoc network and connection between any predefined devices. The called users will receive a message with the option to connect to the initiating device and/or to the tracked device (the subject's).

In some embodiments of the invention, the escort or any user's device using the system that was granted with the privilege to do so, may contact the user of the devices that communicated with the subject's device directly in any communication mean available between their devices. In other embodiments of the invention, the system will store communication mean (such as phone numbers, email address etc) of the tracker device users and will provide them to the escort when necessary.

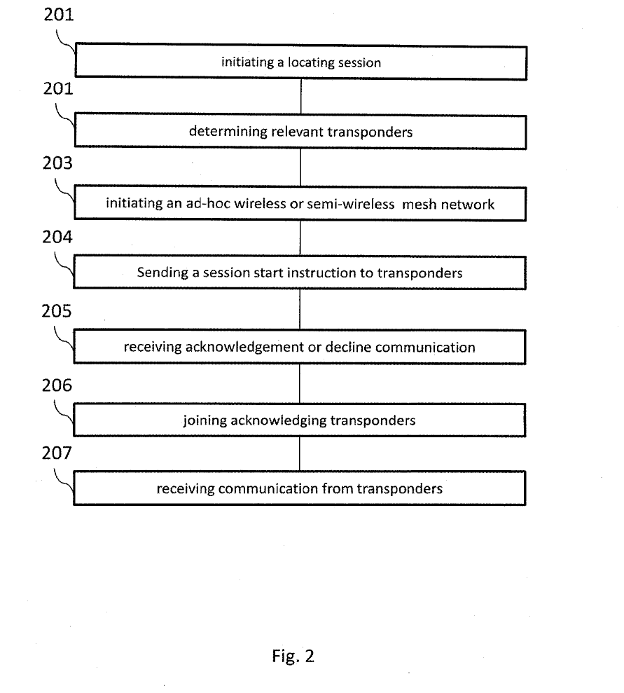

FIG. 2 illustrate an embodiment of the invention, comprising method for tracking the position of a subject, comprising steps of: initiating a locating session (201); determining relevant transponders for the session (202); initiating an ad-hoc wireless or semi-wireless mesh network (203); sending a session start instruction to transponders configured for tracking an object (204); receiving acknowledgement or decline communication from the transponders (205); joining acknowledging transponders to the mesh network (206); and receiving communication from the transponders regarding their communication or lack of communication with the transponder configured for being located (207), wherein the at least one transponder configured to initiate tracking session receives the communication regarding their communication or lack of communication with the transponder configured for being located via the mesh network.

Search session may end in various scenarios, for example:
a. when location information is sent to the escort and the escort or the system approved to end the session;
b. when the escort's device is in a predetermined proximity to the subject's device;
c. when the escort cancel the search session.

In some embodiments of the invention, a search session may be initiated with the activation of only some of the devices known to be in proximity of the last known location of the subject's device. Once one of the tracker devices communicate with the subject's device the system may terminate the session for devices that are not in close proximity to the subject's device and activate other devices in the proximity of the subject's device, hence allowing for a closer and focused search session that allows a more accurate calculation of the subject's location.

In some embodiments of the invention, the system may, after a predefined period of time without communication with the subject's device (i.e. the system does not find the subject's device), enlarge the search grid exponentially, i.e. to send a an activation note by all the devices in the outer perimeter of the search to all the tracking devices of the system that are out of the current search perimeter.

In some embodiments of the invention, when a search session ends, the users of the tracker devices will be informed that the session has ended. In other embodiments, the users may request for an update, and the escort may or may not provide such information to one, a group or all of the users.

In one embodiment of the invention, a user may be compensated for his participation and/or for his positive role in the search session.

In some embodiments of the invention, the initiation of a search session will be limited to a specific device or may be initiated for a set (predefined or not) of devices.

In one embodiment of the invention, the system or the escort will initiate the search using the devices known or believed to be the closest to the last known location of the subject's device. As the search progresses, the system or the escort may manually or automatically (for example in a predefined period of time) expend the search. In some embodiments of the invention, each device may initiate an expansion note (automatically or according to the device's user approval or decision), for example if the device momentarily communicated with the subject's device and lost the signal—a new, geographical initiation note may be sent and expand the search in order to re-communicate with the subject's device.

In other embodiments of the invention, at least two types of searches are available:
a. long range search—a long range search may be performed when the subject's device is relatively far away from the escort initiating the search; the search may be performed while utilizing the escort application “radar” view allowing the escort to create a user interface that presents the route between his present position and the location of the subject's device.
b. short range search—when the range between the subject's device and the escort is shorter than a predefined range, the software application will present a “close range” user interface mode allowing for a directional display that may present, for example, an arrow or other indicator showing the direction in which the subject's device last tracked location.

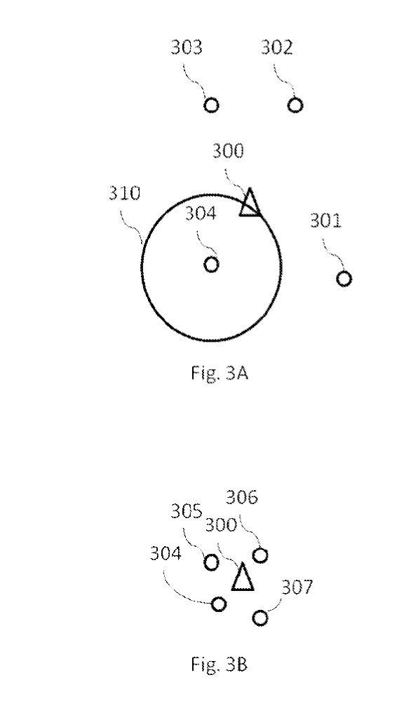

FIGS. 3A and 3B illustrate an embodiment of the invention. In FIG. 3A the system first tracks the last known location of the subject 300 using stored data, then, a search session is initiated with trackers located around the approximated location of subject or around the lastly reported known location of the subject 300. The system starts the search session and adds some of closest tracker devices available 301-304. In case one of the trackers 304 has a momentarily communication with the subject's device (while the subject's device is in communication range 310), the system may cancel the search session for some of the tracker devices (301,302,303) as demonstrated in FIG. 3B and start a session with the current closest tracker devices 305-307, while alerting the user of the tracker device 304 and presenting the direction to the estimated location of the subject.

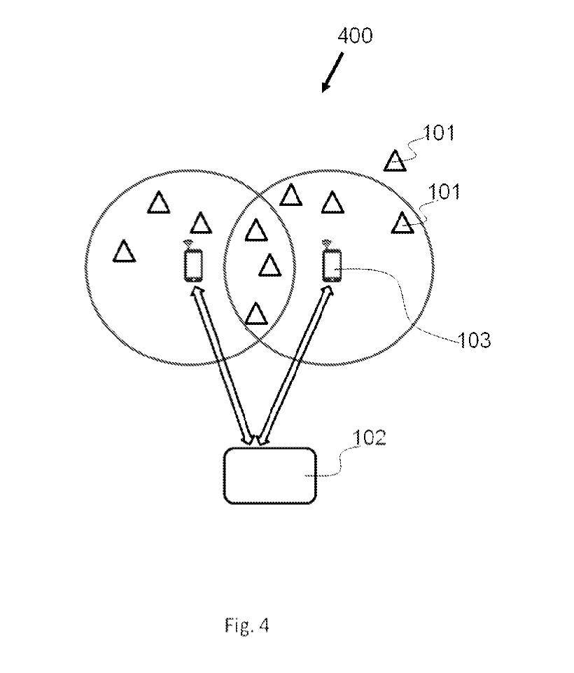

FIG. 4 illustrates an embodiment of the invention, describing another system (400) for tracking a stationary and/or dynamic location of at least one transponder (101) emitting identifying signals, the system (400) comprising:
(a) a software application embedded within at least one smart-phone (103), configured to at least temporarily gather and forwardly transfer the identifying signals emitting from the at least one transponder;
(b) at least one communication means for enabling wireless communication between the at least one transponder and the at least one smart-phone;
(c) at least one computing server (102), in wireless communication with the at least one smart-phone (101);
   wherein the computing server (102) is configured to collect and aggregate the identifying signals transferred by the at least one smart-phone, by mean of crowd-sourcing data, and accordingly process a real-time estimated location of each of the at least one transponder (103,104).

It is demonstrated in FIG. 4 how each of the two demonstrated smart-phones (103) are each communicating and receiving data from some transponders (101) within their reception area, and were few of the transponders are in communication with them both smart-phone (103), therefore data is transferred to the computing-server (102) aggregated and the location of the transponders (101) is accordingly calculated.

According to an embodiment of the present invention, while users activate the above mentioned application, applied in their smart-phone, each of the smart-phones constantly scans the area (with no need for initialization) for any transponder in its area and reports on what it finds. Therefore, crowd-sourced communication data is created and a computing cloud calculates the location of the transponders from all data received from each and every smart-phone.

In an embodiment of the invention, each of the tracker users may send an emergency message in any communication method available to its device so other people activate their software, or may download the software application or an emergency version of the software application, that will allow them to join their computing device to the specific search or to searches in general. For example, a tracker device may send a text message to others containing a hyperlink to the emergency software with or without a personal comment. In other embodiments of the invention, the system may suggest a user of tracker device's to send such emergency messages.

In one embodiment of the invention, each user of tracker device may refuse, in real-time or by using a predefined parameter, to join a search.

In some embodiments of the invention, a tracker device user may be alerted or view the last known location of the subject's device and/or the current location, in case his device has communicated with subject's device and/or if the search parameters allow for him to view the information. The information may allow the user to actively participate in the search, if he or she decides to do so.

In some embodiments of the invention, the software application will be always active in the background or foreground in all or some of the devices. In other embodiments the software application will be activated only upon a demand, for example in the following manner, once a tracking session is initiated the system may send an initiation note, using the central server and/or any one of the computing devices, for example by ways of text message; mms message; email; phone call; data package; return ping to the device's query etc. The initiation note may be sent according to several parameters, for example:
a. affiliation of the user of the tracker computing device;
b. current location of the subject's device;
c. current location of the tracker device;
d. projected location of the subject's device;
e. projected location of the tracker device;
f. past location of the subject's device;
g. past location of the tracker device;

In some embodiments of the invention, the system will be initiating a search according to predefined initiating events. The initiating events may be based upon several parameters, for example:
a. time based parameters—if the escort (on behalf of the subject) or the subject did not “check in” (i.e. connected to the system from a predefined location) on a specific time; for example, a child that should have pressed a button in the software application's user interface on a specific hour noting that he is OK, or the software is expected for an automatic “check in” based on the device location sensors, and that did not happen.
b. location based parameters—for example, if the subject is in a predefined unsafe area or outside a predefined safe area; for example, out of the safe zone of the school yard;
c. combined time and location parameters—for example, if a child is not in school during school hours.
d. escort-based parameters—for example, the parents of a child equipped with a device that is escorted by his big brother who also equipped with a device equipped with the software (both siblings are carrying devices), may be alerted in case their children are not together anymore (i.e. the devices are no longer in communication with one another);
e. “search me”—a “search me” mode may be configured, where the subject initiates a search asking to be found; and where the system, a predefined user, an approximate and/or a random user, is appointed as the escort or appoints another user as the escort.

In some embodiment of the invention, the communication network formed by the devices would be a wireless mesh network, hence, may be seen as a special type of wireless ad-hoc network deployed to provide dynamic connectivity over a certain geographic area or an ad-hoc network i.e. with wireless devices within communication range of each other. The mesh routers may be mobile or stationary.

In some embodiment of the invention, statistics regarding the subject or any of the users may be provided in real-time and/or after the termination of the session. The provided statistics may include:
a. most popular locations;
b. routs traveled;
c. friends spent time with;
d. locations accuracy average;
e. network coverage statistics;
f. number and type of interactions between devices, and between devices and smart-phones.

In some embodiment of the invention, the system may provide, after the termination of the session, a reconstructed virtual route showing the movement of the subject in a sort of “lighthouse” navigation, showing the locations of the subject's device over time. This view may show information calculated after hand, such information is not calculable on real-time.

In some embodiment of the invention, the system comprises:
a. at least one subject's computing device comprising a transponder configured for being located;
b. at least one escort computing device comprising a transponder and configured for enabling and disabling tracking session;
c. at least two tracker computing devices comprising transponders configured for tracking the at least one transponder configured for being located; and
d. means for enabling communication between the transponders.

In some embodiments of the invention, the system comprises an ad-hoc wireless (when all the computing devices are connected via wireless networks) or semi-wireless network (when some of the computing devices are connected using wire and other wireless).

In some embodiments of the invention, the tracker computing devices may send central server, network or escort's computing device communication from the regarding their communication or lack of communication with subject's computing device.

1-47. (canceled)

48. A system (100) for tracking a stationary and/or dynamic location of at least one user, temporarily defined as subject-user, comprising:
(a) at least three transponders (101,103,104), each associated with a different user; each of said transponders configured to temporarily emit identifying signals, transfer and/or gather said identifying signals emitting from at least one other said transponders;
(b) at least one communication means for enabling wireless communication for said transponders' signals; and
(c) at least one computing server (102), in communication with said transponders, configured to control said communication;
wherein at least one of said transponders, associated with said subject-user, is temporarily characterized as a subject-transponder (101);
at least two of said transporters are temporarily characterized as tracking-transponders (103,104), configured to temporarily track said signals emitting from said subject-transponder (101), by means of a tracking search for its said subject-user;
said computing server (102) is configured to form an ad-hoc communication mesh network (106) between said at least two tracking-transponders (103,104), collect data from their said signals and accordingly process a real-time estimated location of said subject-transponder (101).

49. The system according to claim 48, wherein at least one of said transponders configured to temporarily serve as an escort-transponder (103) for at least one of said at least one subject-transponder (101), by means of at least one of the following:
(a) select which of said transponders may participate in said search, as said tracking-transponder;
(b) select which of said transponders may initiate said search;
(c) select which of said tracking-transponders (103,104,105) may terminate said search;
(d) select at least one parameter, by which said search is to be conducted, selected from a group consisting of: at least one predefined location, at least one recent location, and relationship of said subject-user with said users of at least one other of said transponders;
(e) select which of said tracking-transponders (103,104,105) may receive, from said computing server (102) or via said transponders, real-time and/or off-line tracking information, regarding said search; and
(f) select which of said tracking-transponders (103,104,105) may invite at least one new tracking-transponder to participate in said search; invitation may be sent to an exciting said user or a new user introduced with said transponders.

50. The system according to claim 48, wherein said data collection is directly from said tracking-transponders, which communicate with said subject-transponder and/or via other said tracking-transponders, by means of said mesh-network (106).

51. The system according to claim 48, wherein each of said transponders is embedded within a device (108) selected from a group consisting of: smart-phone, desktop computer, laptop computer, bracelet, necklace, tablet, and any combination thereof.

52. The system according to claim 51, wherein said device is configured for wireless communication, at least partial wireless communication and/or non-wireless communication.

53. The system according to claim 48, wherein said computing server (102) is temporarily embedded within at least one of said transponders.

54. The system according to claim 48, wherein said means for communication (106) is selected from a group of: Bluetooth, Bluetooth Low Energy (BLE), Wi-Fi, Sub-Giga, cellular, ZigBee, Radio-frequency, Radio-frequency identification (RFID), and any combination thereof;

55. The system according to claim 48, wherein said system (100) further comprising a database (107), embedded within said computing server (102), configured to store at least one feature of at least one of said transponders; said feature selected from a group consisting of: recent location, most popular locations, communication properties, contact information, relation status with other said users, contact information of related other said users, personal appearance, and medical record.

56. The system according to claim 55, wherein said computing server (102) configured to transfer at least of said at least one feature to at least one predetermined said transponders.

57. The system according to claim 48, wherein said process of said estimated location is achieved by means of triangulation; said estimated location may be denoted with or without intentional direction.

58. The system according to claim 48, wherein said subject-user is a human, an animal, or an object.

59. The system according to claim 48, wherein said subject-transponder (101) may also be temporarily characterized as said tracking-transponder, therefore also included in said mesh network (106).

60. The system according to claim 48, wherein at least one of said transponders is configured as a communication node.

61. A method for tracking location of at least one user, temporarily defined as subject-user, comprising steps of:
(a) providing at least three users with transponders (101,103,104); said transponders configured to temporarily emit identifying signals, transfer and/or gather said identifying signals emitting from other said transponders;
(b) providing means for enabling communication between said transponders' signals and a central computing (102) for controlling said communication;
(c) initiating a search;
(d) temporarily characterizing at least one of transponders, associated with said subject-user, as a subject-transponder (101);
(e) temporarily characterizing at least two of transponders as tracking-transponders (103,104), configured for tracking said signals emitting from said subject-transponder (101);
(f) forming an ad-hoc communication mesh network (106) between said at least two tracking-transponders (103,104);
(g) collecting data from said signals of said tracking-transponders regarding said location of said subject-transponder (101);
(h) processing said data to a real-time estimated location of said subject-transponder (101); and
(i) terminating said search, by at least one predetermined tracking-transponder, and/or by a predetermined event of locating said subject-transponder (101).

62. The method according to claim 61, further comprising step of temporarily characterizing at least one of said transponders to serve as an escort-transponder (103) for at least one of said subject-transponder (101), by means of at least one of the following:
(a) selecting which of said transponders may participate in said search, as said tracking-transponder;
(b) selecting which of said transponders may initiate said search;
(c) selecting which of said tracking-transponders (103,104,105) may terminate said search;
(d) selecting at least one parameter, by which said search is to be conducted, selected from a group consisting of: at least one predefined location, at least one recent location, and relationship of subject-user with said users of at least one other said transponders;
(e) selecting which of said tracking-transponders (103,104,105) may receive real-time and/or off-line tracking information, regarding said search; and
(f) selecting which of said tracking-transponders (103,104,105) may invite at least one new tracking-transponder to participate in said search; invitation may be sent to an exciting said user or a new user introduced with said transponders.

63. The method according to claim 61, further comprising the step of utilizing said method by means of a software application, configured to be instantly downloaded.

64. The method according to claim 61, wherein said step of initiating is according to at least one event selected from a group consisting of:
(a) an initiation by at least one predetermined said transponders and/or an initiation by said escort-transponder (103) of said subject-transponder;
(b) said subject-transponder is located within a predetermined unsafe area;
(c) said subject-transponder is located outside at a predetermined safe area;
(d) distance of said subject-transponder from its escort-transponder, a predetermined transponder, and/or predetermined location is above a predetermined value; and
(e) distance of said subject-transponder from a predetermined transponder, and/or predetermined location is below a predetermined value.

65. The method according to claim 61, wherein said step of selecting said at least two tracking-transponders (103,104) is according at least one feature selected from a group consisting of:
(a) perimeter distance from last known location of said subject-transponder (101);
(b) perimeter distance from said escort-transponder (103);
(c) perimeter distance from at least one of said tracking-transponders (103,104,105) recently receiving said signal from said subject-transponder (101); and
(d) predetermined relation between said subject-user of said subject-transponder (101) and said user of at least one of said transponders.

66. The method according to claim 61, wherein said ad-hoc communication mesh network (106) is at least partially supported by wireless crowd-sourcing network, further comprising steps of:
(a) initiating said software application;
(b) searching for available said crowd-sourcing network; and
(c) connecting said transponder to said ad-hoc communication mesh network, via said crowd-sourcing wireless network.

67. A system (400) for tracking a stationary and/or dynamic location of at least one transponder (101) emitting identifying signals, said system (400) comprising:
(a) a software application embedded within at least one smart-phone (103), configured to at least temporarily gather and forwardly transfer said identifying signals emitting from said at least one transponder;
(b) at least one communication means for enabling wireless communication between said at least one transponder and said at least one smart-phone; and
(c) at least one computing server (102), in wireless communication with said at least one smart-phone (101);
wherein said computing server (102) is configured to collect and aggregate said identifying signals transferred by said at least one smart-phone, by mean of crowd-sourcing data, and accordingly process a real-time estimated location of each of said at least one transponder (103,104);
wherein said communication means is at least partially supported by crowd-sourcing network;
wherein at least one of said smart-phones is configured as a communication node.
